(19) United States
(12) Patent Application Publication
(10) Pub. No.: US 2010/0070728 A1
(43) Pub. Date: Mar. 18, 2010

(54) METHOD AND APPARATUS FOR AUTHENTICATING USER ACCESS TO DISK DRIVE

(75) Inventors: Michael James, Longmont, CO (US); Darren Lasko, Longmont, CO (US)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/209,925

(22) Filed: Sep. 12, 2008

(51) Int. Cl. G06F 12/14; G06F 12/00

(52) U.S. Cl. 711/164; 711/163; 711/112; 711/103; 711/E12.001; 711/E12.091; 711/E12.093

(57) ABSTRACT

A disk apparatus is configured to be connected to a host device, and has a security program for preventing unauthorized user access to the disk apparatus. A disk medium stores a boot program for executing a boot process of the disk apparatus, and a security program storage device stores the security program. A processor is provided for retrieving the security program from the storage device and enabling the host device to execute the security program. The boot program is executed by the host device when the host device determines from executing the security system that the disk apparatus may be accessed by the user.

### FIELD OF INVENTION

The present invention relates to disk drives, and in particular, to a secure disk drive for preventing unauthorized data access.

### BACKGROUND OF THE INVENTION

For protection against unauthorized data access, conventional secure disk drives have a partition on a disk that stores software for authenticating credentials of the user before allowing the data to be read. This partition is referred to as a master boot record shadow (MBRS). More specifically, the MBRS stores a small security program (also known as pre boot authentication (PBA) program) on some hidden sectors of a disk, and the program is executed to authenticate the credentials of the user when he/she attempts to initially access the data stored on the disk drive through a host, i.e., when the computer boots up.

Since the security program in the MBRS is accessed when the host or computer to which the disk drive is connected is first powered or booted on, the disk in the drive must spin up to the proper operating speed before the program can be accessed and executed. As shown in FIG. 5, a process for accessing and executing the security program in the MBRS program generally includes a spin up component 64 and a data access component 66 having multiple individual data accesses 1-N. A SPIN UP is the time it takes for the disk to reach its normal operational speed. Each individual data access is further separated into a number of processes including a data request (REQUEST) from the host to access a portion of the security program in the MBRS; moving the head to the target track or tracks of the specified portion of the MBRS (SEEK); reading the portion of the security program from the disk (READ); sending the data to the host (SEND); and using the data to execute the retrieved portion of the security program (EXEC). The time required for accessing and performing the entire security program is generally divided as follows:

| | | |
|---|---|---|
| SPIN UP | 5 | sec |
| REQUEST | 100 | microsec |
| SEEK | 3 | msec |
| READ | 1 | msec |
| SEND | 1 | msec |
| EXEC | 100 | microsec |

The REQUEST, SEEK, READ, SEND and EXEC processes are repeated multiple times (on the order of approximately 1,000 times). Thus, the total time for accessing and performing the security program in the MBRS in a conventional secure disk drive can be as long as 10 seconds, which many users find unsatisfactory.

### SUMMARY OF THE INVENTION

The present invention is directed to a disk apparatus which is configured to be connected to a host device and having a security program for preventing unauthorized user access. One or more storage devices within the disk apparatus store a boot program for executing a boot process, a security program, and user data. A processor is provided for retrieving the security program from the storage device and enabling the host device to execute the security program. The boot program is executed by the host device to determine that the disk apparatus may be accessed by the user. The present invention reduces the credential authentication process time in a disk apparatus having a security program for preventing unauthorized user access.

### BRIEF DESCRIPTION OF THE DRAWINGS

FIG. 1 is block diagram of a disk drive in accordance with one embodiment of the present invention;

FIG. 2 is a flowchart describing a process for enabling access to the disk drive in accordance with one embodiment of the present invention;

FIG. 3 is a flowchart describing a process for executing a security program;

FIG. 4 is a diagram illustrating the components of a process for accessing and executing a security program in the disk drive of the present invention; and

FIG. 5 is a diagram illustrating the components of a process for accessing and executing a security program in a conventional disk drive system.

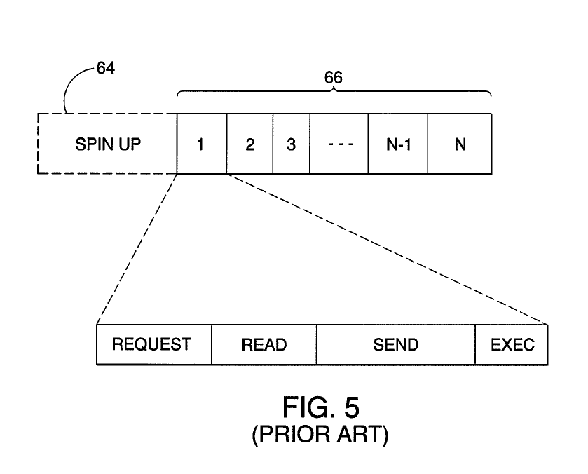

### DETAILED DESCRIPTION OF THE PREFERRED EMBODIMENTS

Broadly stated, the present invention is directed to a secure disk drive for preventing unauthorized data access. The disk drive includes a non-volatile memory for storing a security program. A host device attempting to boot from the disk drive is initially directed to the security program which executes to authenticate a user to the disk drive. If the authentication is successful, the disk drive allows access to the normal boot program and user data. Storing the security program in a non-volatile memory of a disk drive significantly reduces the time for accessing or executing the security program, since the spin up time required to bring the disk to a normal operating speed and seek time to bring the disk read head over the correct track is eliminated, as in conventional secure disk drives that store authentication programs on some partition sectors of a disk.

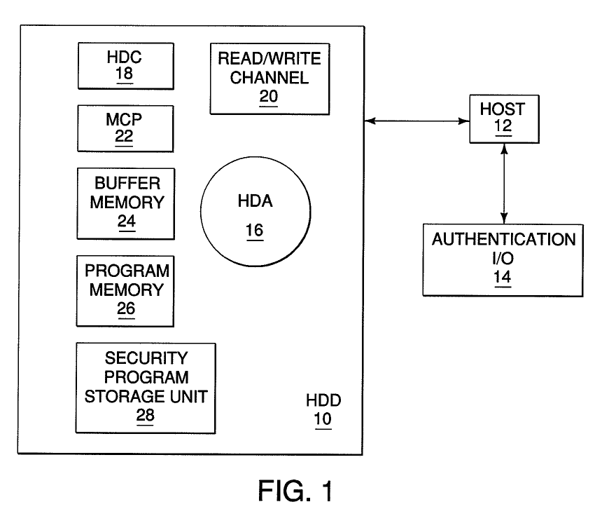

Turning now to FIG. 1, a hard disk drive (HDD) 10 in accordance with one embodiment of the invention is configured to be communicatively connected to a host 12, such as a laptop computer, a PC or any devices such as file servers that employ a disk drive for storage of information. The host 12 is operatively connected to one or more authentication input/output device(s) 14 such as a keyboard, a fingerprint reader, a palm reader or a smart card reader, for example, for allowing a user to enter authentication information for accessing the HDD 10.

The HDD 10 may be magnetic, optical or magneto-optical disk drives, and includes a head disk assembly (HDA) 16, a hard disk controller (HDC) 18 and a read/write channel 20. The HDA 16, although not shown, includes one or more magnetic, optical or magneto-optical disks, a spindle motor for rotating the disks, read/write heads corresponding to the disks for reading data from and writing data on the disks, and a head actuator for positioning the heads on the disks.

The HDC 18, in cooperation with a main control processor (described below), processes commands from the host 12, and accepts data from and transmits disk data to the host device. Status to the host 12 regarding successes and errors relating to the processing of commands is also generated by the HDC 18. The HDC 18 also controls the HDA 16 including the rotational speed of the spindle motor used to rotate the disks, and the positioning of the read/write head(s) in the HDA.

The read/write channel 20 is provided for translation of digital data from the HDC 18 to a format capable of being either written to, or read from the disk(s) in the HDA 16. In a disk write operation, the read/write channel 20 sends signals to the write head and a preamp to cause magnetic transitions to be “written” to the disks. For a disk read operation, the read/write channel 20 decodes the signals from the read head and the preamp, generated by passing over the magnetic domains written on the disks. The transitions are detected and processed in a manner that allows them to be converted into a data format usable by the HDC 18 and the host 12.

The HDD 10 further includes a main control processor (MCP) 22, a buffer memory 24 and a program memory 26. The MCP 22, in cooperation with the HDC 18, is provided for the overall control of the HDD 10 including the control and management of the mechanical positioning of the read/write head(s) and rotational media (motor controls) in the HDA 16, management of the buffer memory 24 and its caching algorithms, the control and setup of the read/write channel 20 and the host interface, for example. The program memory 26 stores programs and tables (not shown) used in accomplishing the above-mentioned MCP 22 responsibilities, including read channel and buffer management cache tables, and codes to be executed by the MCP 22. The program memory 26 is implemented in a non-volatile device such as a flash memory or a ROM. The buffer memory 24 stores data used by the MCP 22, data used by the HDC 18, and user data to be transferred between the host 12 and disk media in the HDA 16.

The HDD 10 in accordance with one embodiment of the invention further includes a storage unit 28 for storing a security program which enables the host 12 to collect the authentication credentials of a user requesting access to the HDD and send them to the HDD. The security program storage unit 28 is a non-volatile memory such as a flash memory, which retains data when the HDD 10 is powered off. While the security program storage unit 28 is shown as an independent component of the HDD 10, it may also be provided in a portion of some other non-volatile storage device available on the HDD, such as a flash memory used as cache for user data or the program memory 26.

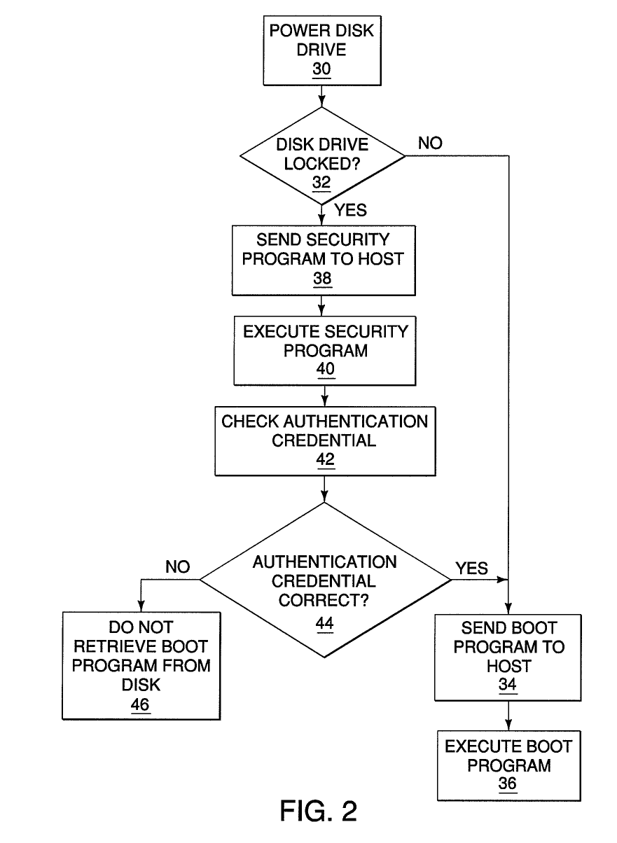

Referring to FIG. 2, the operation of the HDD 10 for authenticating the credentials of a user is described. When the host 12 and HDD 10 power on (Block 30), the host attempts to boot from the HDD 10 and the MCP 22 determines whether the HDD is locked (Block 32); i.e., whether an authentication of the user is required. If the HDD 10 is not locked, the MCP 22 retrieves a boot program from the disk (Block 34), and sends it to the host 12 to execute the boot process (Block 36), allowing the user access to the HDD 10.

If, however, the MCP 22 determines that the HDD 10 is locked, it retrieves the security program from the storage unit 28 (Block 38), and sends it to the host 12 to execute the security program to collect authentication credentials from the user and send them to the HDD (Block 40). The MCP 22 then checks the authentication credentials to determine whether they are correct (Block 42). If the MCP 22 determines that the authentication credentials are correct (Block 44), it informs the security program running on the host 12 of the authentication success, and unlocks the HDD and retrieves the boot program from the disk (Block 34) and sends it to the host to execute the boot process (Block 36), so that the user has access to the HDD.

If, however, the MCP 22 determines that the authentication credentials are not correct (Block 44), the MCP 22 keeps the HDD in the locked state and informs the security program running on the host of the authentication failure. The MCP 22 does not retrieve the boot program from the disk (Block 46), so that the host 12 does not run the boot process. As a result, the user is denied access to the HDD 10.

In the above-described operation of the HDD 10, the boot program is stored in a disk in the HDA 16. Alternatively, the boot program may also be stored in a non-volatile storage device in the HDD 10, instead of a disk. For example, the boot program may be stored in a separate storage device such as a flash memory or in the security program storage unit 28 or the program memory 26.

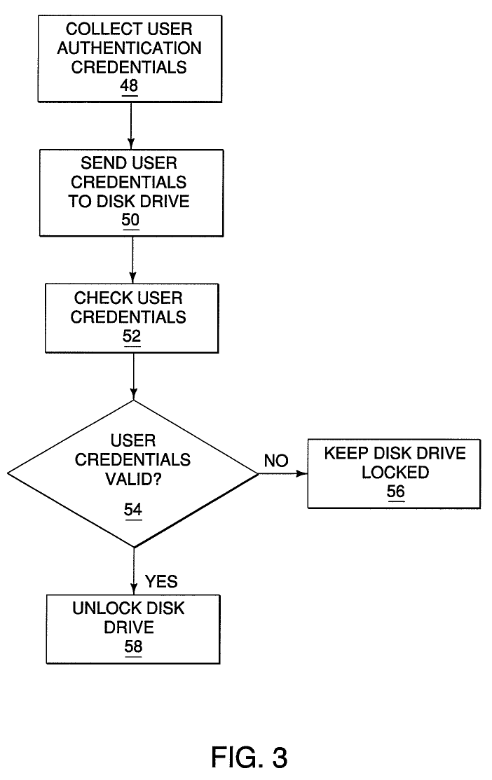

Turning now to FIG. 3, the execution of the security program by the host 12 (described above in Block 40) is described in accordance with one embodiment of the present invention. The security program calls for the host 12 to collect authentication credentials from the user through the authentication I/O device 14, such as a password entered through a keyboard, or reading of the user's fingerprint or palm through a reader or a smartcard (Block 48). The host 12 then sends the authentication credentials to the HDD 10 (Block 50), where the MCP 22 checks the credentials by comparing them against credentials previously stored on the HDD (Block 52). In one embodiment, the credentials are stored in the program memory 26. However, the credentials may also be stored in any other non-volatile storage in the HDD 10. The MCP 22 communicates the result of the comparison to the host 12. If the credentials supplied by the user are not valid (Block 54), the HDD 10 is kept locked, as described above in Blocks 42, 44 and 46 (Block 56). If, however, the user credentials are valid, the HDD 10 is unlocked to enable the user access to the data in the HDD, as described above in Blocks 42, 44, 34 and 36 (Block 58).

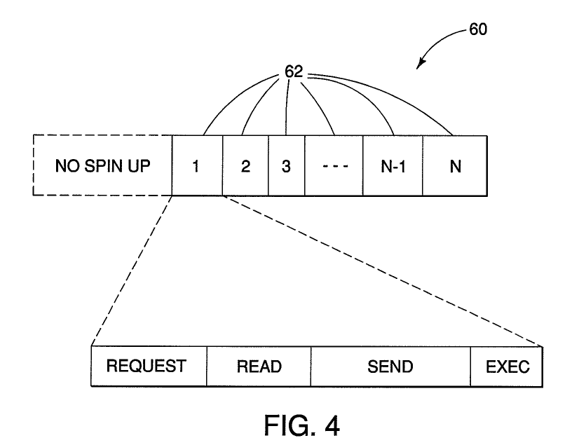

Referring to FIG. 4, the components of a process for accessing the security program in accordance with an embodiment of the invention includes direct data accesses 60, which are separated into several individual data accesses 62. Each individual data access is further separated into a number of processes including a data request (REQUEST) from the host 12 to access a portion of the security program stored in the storage unit 28; reading the security program from the storage unit (READ), sending the security program to the host 12 (SEND) and executing the retrieved portion of the security program by the host (EXEC). Significantly, the process for accessing the security program in accordance with the present invention does not include a spin up waiting period or the SEEK period for moving the head to the target sector or sectors, as in conventional secure disk drives.

The time required for accessing and performing the security program is generally divided as follows:

| | | |
|---|---|---|
| REQ | 100 | microsec. |
| READ | 1 | msec |
| SEND | 1 | msec |
| EXEC | 100 | microsec |

The process above is repeated multiple times (on the order of approximately 1,000 times) for a total time of less than 3 seconds. Thus, the total time for accessing and performing the security program in accordance with the present invention is approximately seven seconds less than for known disk drives. In this manner, the HDD 10 of the invention provides a speedier authentication process for a better user experience.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A disk apparatus configured to be connected to a host device, and having a security program for preventing unauthorized user access to the disk apparatus, said apparatus comprising:
a disk medium storing a boot program for executing a boot process of said disk apparatus;
a security program storage unit storing the security program; and
a processor for retrieving the security program from the security program storage unit and enabling the host device to execute the security program;
wherein the boot program is executed when the host device determines from executing the security program that the disk apparatus may be accessed by the user.

2. The disk apparatus as defined in claim 1, wherein said processor retrieves the security program from said security program storage unit when the disk apparatus is locked.

3. The disk apparatus as defined in claim 2, wherein the security program determines that the user is authorized to access the disk apparatus when credential information provided by the user matches authentication information stored in the disk apparatus.

4. The disk apparatus as defined in claim 3, wherein said authentication information is stored in a program memory for storing data used by said processor.

5. The disk apparatus as defined in claim 1, wherein said security program storage unit comprises a non-volatile memory.

6. The disk apparatus as defined in claim 5, wherein said security program storage unit comprises a flash memory.

7. The disk apparatus as defined in claim 1, wherein said security program storage unit is provided in a flash memory used as cache for user data or a program memory for storing data used by said processor.

8. A method for preventing unauthorized user access to a disk apparatus, comprising:
storing a boot program for executing a boot process of the disk apparatus on a disk medium in the disk apparatus;
storing a security program for accessing said boot program in a non-volatile storage unit in the disk apparatus;
retrieving the security program from the storage unit and enabling a host device operatively connected to the disk apparatus to execute the security program when an access is requested by a user; and
retrieving the boot program from the disk medium and enabling the host device to execute the boot program if it is determined from executing the security program that the disk apparatus may be accessed by the user.

9. The method as defined in claim 8, wherein the security program is retrieved from said storage unit when the disk apparatus is locked.

10. The method as defined in claim 8, wherein the security program determines that the user is authorized to access the disk apparatus when credential information provided by the user during the execution of the security program matches authentication information stored in the disk apparatus.

11. A method for reducing a credential authentication process in a disk apparatus, comprising:
storing a security program for accessing a boot program in a non-volatile storage unit in the disk apparatus; and
retrieving the security program from the storage unit and enabling a host device operatively connected to the disk apparatus to execute the security program when an access is requested by a user;
wherein the security program is retrieved from the storage unit without waiting for a disk medium in the disk apparatus to reach an operating speed.

12. The method as defined in claim 11, wherein said non-volatile storage device is a flash memory.

13. A method for reducing a boot process time in a disk apparatus having a security program for preventing unauthorized user access, comprising:
storing a boot program for executing a boot process of the disk apparatus in a storage device in the disk apparatus;
storing a security program for enabling access to said boot program in a non-volatile storage unit in the disk apparatus;
retrieving the security program from the storage device and enabling a host device operatively connected to the disk apparatus to execute the security program when an access is requested by a user; and
retrieving the boot program from the storage device and enabling the host device to execute the boot program if it is determined from executing the security program that the disk apparatus may be accessed by the user;
wherein the security program is retrieved from the storage unit without waiting for a disk medium to reach an operating speed.

14. The method as defined in claim 13, wherein the storage device is a disk medium.

15. The method as defined in claim 13, wherein the storage unit is a flash memory.

16. A security apparatus for a disk device configured to be in communication with a host device, the disk device having a main control processor and a disk medium that stores a boot program for executing a boot process of the disk device, said security apparatus comprising:
a security program storage unit storing a security program for preventing unauthorized user access to the disk device;
wherein the main control processor retrieves said security program from said security program storage unit and enables the host device to execute the security program, and
the boot program is executed when the host device determines that the disk device may be accessed by the user.

17. The security apparatus as defined in claim 16, wherein the security program determines that the user is authorized to access the disk device when credential information provided by the user matches authentication information stored in the disk drive.

18. The disk apparatus as defined in claim 16, wherein said security program storage unit comprises a non-volatile memory.

19. The security apparatus as defined in claim 18, wherein said security program storage unit comprises a flash memory.

20. The security apparatus as defined in claim 18, wherein said security program storage unit is provided in a flash memory used as cache for user data or a program memory for storing data used by said main control processor.
